(19) United States
(12) Patent Application Publication
(10) Pub. No.: US 2026/0283300 A1
(43) Pub. Date: Sep. 24, 2026

(54) INSOLE

(71) Applicants: Larus GUNNSTEINSSON, Reykjavik (IS); Gudmundur Gauti REYNISSON, Gardabaer (IS)

(72) Inventors: Larus GUNNSTEINSSON, Reykjavik (IS); Gudmundur Gauti REYNISSON, Gardabaer (IS)

(21) Appl. No.: 19/476,300

(22) PCT Filed: Apr. 18, 2024
(86) PCT No.: PCT/IS2024/050001

§ 371 Date: Oct. 17, 2025

(30) Foreign Application Priority Data
Apr. 18, 2023 (IS) 050397

(51) Int. Cl. A43B 13/04; A43B 7/142; A43B 7/1425; A43B 7/144; A43B 7/145; A43B 7/1455; A43B 17/14

(52) U.S. Cl. CPC A43B 13/04; A43B 7/142; A43B 7/1425; A43B 7/144; A43B 7/145; A43B 7/146; A43B 17/14

(57) ABSTRACT

The present invention relates to a footbed, an insole, and a shoe designed for orthotic purposes giving cushion and support for the foot. The footbed has a base portion for supporting the foot and a plurality of pads positioned within the outer perimeter of the footbed, such as a heel pad, an outer sole pad, an inner sole pad, a metatarsal joints pad, and two or more toe pads. The footbed may including the base and the plurality of pads has an upwardly extending outer perimeter where the shape of the base and the plurality of pads provides a three-dimensional shape of a footbed for support and treatment of the foot.

### FIELD OF THE INVENTION

The invention relates to an orthotic insole, an orthotic footbed and an orthotic shoe, with a padded upper insole.

### BACKGROUND

There is a myriad of different solutions involving insoles or special made footbeds for support and different orthotic purposes. Insoles have been offered for a long time for comfort of the foot and to alleviate congenital and acquired problems with the foot and symptoms relating to the foot, back, knee and hip. Inserts for used to prevent or alleviate orthotic problems can be off-the-shelf products or custom made by specialists. While many insoles are provided for simple support such as arch support other insole products are padded for stimulating different areas under the foot.

WO17222944 discloses includes a three-dimensional orthotic footbed assembly which closely approximates a size and configuration of a particular foot as well as a method for of making the orthotic footbed assembly. The method includes direct printing of orthotic features onto a 3-D footbed.

WO07044983 discloses a custom-made insole being individually adaptable for insertion in footwear with an upper cradle having an upper surface for contact with a foot. The upper surface is made from ETC material, whereas the lower interlocking surface is moulded of EVA for cushioning of the foot. The insole further comprises a lower cradle with an arch depression and a lower surface and a number of flow domes. Each flow dome has a flow hole fluidly communicating with the arch depression and a gel layer is placed in the arch depression, the gel layer being mouldable via heat treatment. The insole is heated to allow the gel layer to soften before the user then places their foot on the insole for the gel layer to conform to the user's foot.

### SUMMARY OF THE INVENTION

The present invention provides a footbed, an insole, and a shoe, with a padded upper portion designed for orthotic purposes. The footbed or the upper insole of the present invention provides a comfortable support under the whole foot by giving cushion, support, and minimal alignment for the foot. The footbed design of the present invention has a universal design in that it suits people with different shape of feet, such as people with high, flat, and normal arch and may be part of a footbed assembly, an insole, orthotic insert or forms a portion or the whole sole of a shoe.

The footbed of the present invention has a base portion for supporting the foot and a plurality of pads positioned within the outer perimeter of the footbed. The footbed comprises a heel pad, an outer sole pad, an inner sole pad, a metatarsal joints pad, and five toe pads. The footbed may including the base and the plurality of pads may be formed as a single component, where the outer perimeter of the footbed is at least partially upwardly extending and where the height outer perimeter, the shape of the base and the shape of the plurality of pads provides a three-dimensional shape of a footbed for support and treatment of the foot.

The footbed of the present invention is designed from a standard of shoe size 41 and the pads are positioned in relation to the anatomy of the foot and both larger and smaller size footbeds and the size are increased or decreased from shoe size according to standardized shoe-making rules and calculations based on the length and width of the foot with an increase of 6.66 millimetres between a whole shoe-size number. Furthermore, the size and position of the pads are also proportionally increased or decreased from a standard of shoe size 41 when making footbeds larger or smaller than size 41.

In some embodiments an footbed is provided with one or more pads for giving relief during walking and to provide absorption to the lower back and spine. The footbed may also provide support the base of one or more of the five metatarsals of the foot as well as well as massaging the kidney nerve by providing one or more padded areas in the footbed.

In some embodiments the footbed of the present invention may comprise one or more padded areas to provide soft support for the arch of the foot as well as providing a massage function during walking and thereby stimulating blood circulation the foot by massaging the nerves in the foot.

In some embodiments an footbed is provided with one or more pads to provide support for the metatarsals support in order to prevent syndromes or conditions such as hammer toes and hallux valgus. The footbed may also provide frontal sinus massage and blood circulation for head and neck by providing one or more padded areas in the footbed.

In some embodiments the footbed of the present invention may comprise one or more padded areas for increasing blood circulation where the position of the padded areas is determined for the purpose of nerve and organ stimulation, moderating malposition of the back and pelvis and for moderating heel spur. In some embodiments the footbed of the present invention may comprises 9 padded areas positioned to create a groove for preventing and/or relieving plantar fasciitis symptoms.

The combination of one or more of the following embodiments provide the solutions presented herein: a) by the position of toe pads behind each toe-tip to increase blood circulation in several organs by massaging the nerves in the toes, b) by the position of the metatarsal joints pad just behind the metatarsal arch to increase blood circulation in several organs by massaging the nerves in the toes, c) by providing a footbed with different hardness in the plurality of pads embedded in the footbed, and d) providing a unique position of the heel pad, the inner sole pad, the outer sole pad and the metatarsal joints pad to prevent and relief symptoms due to plantar fasciitis, which provides the improved device and method of the present invention

It is an object of the present invention to overcome and/or ameliorate the aforementioned drawbacks of the prior art and to provide an improved and/or alternative and/or additional orthotic footbed with plurality of pads. It is one preferred object of the present invention to provide a footbed of an injection moulded shoe. One preferred object of the invention is to provide a footbed assembly comprising an upper layer, a base having an outer perimeter and a plurality of protruded areas in the shape of pads to massage the foot during walking.

The object(s) underlying the present invention is (are) particularly solved by the features defined in the independent claims. The dependent claims relate to preferred embodiments of the present invention. Further additional and/or alternative aspects are discussed below.

Thus, at least one of the preferred objects of the present invention is solved by a footbed comprising i) a base, and ii) a plurality of pads positioned within the outer perimeter on the base. The plurality of pads comprises a) a heel pad, b) an outer sole pad, c) an inner sole pad, d) a metatarsal joints pad, and e) five toe pads.

Another preferred object of the present invention is solved by an injection moulded shoe comprising a sole and an upper part, where the sole and the upper part are formed as a single moulded part from a continuous piece of material. The sole has a footbed comprising a base, said base having an outer perimeter and a plurality of protruded areas in the shape of pads within the outer perimeter on the base to massage the foot during walking.

One of the preferred objects of the present invention is solved by a footbed assembly comprising an upper layer, a base having an outer perimeter and a plurality of protruded areas in the shape of pads within the outer perimeter on the base, where the plurality of pads comprises a) a heel pad, b) an outer sole pad, c) an inner sole pad, d) a metatarsal joints pad, and e) two or more toe pads.

Another preferred object of the present invention is solved by a footbed comprising i) a base, and ii) a plurality of pads positioned within the outer perimeter on the base, where the plurality of pads are nine with i) the centre of a heel pad is positioned to be underneath the middle of the heel bone, ii) an outer sole pad positioned to be underneath the cuboid bone between the heel bone and the talus bone, iii) an inner sole pad positioned to be underneath the medial arch, vi) the highest point of a metatarsal joints pad positioned to be underneath the highest point of the cirque behind the traverse arch formed by the heads of the five metatarsals, and v) five toe pads positioned behind each toe-tip.

Another preferred object of the present invention is solved by a footbed comprising i) a base, and ii) a plurality of pads positioned within the outer perimeter on the base. The plurality of pads comprises a) a heel pad, b) an outer sole pad, c) an inner sole pad, d) a metatarsal joints pad, and e) five toe pads, where the base and the plurality of pads are formed as a single component.

### DESCRIPTION OF THE INVENTION

The following definitions and embodiments relate to the method, the system and the apparatus of the invention.

In the present context the terms “insole” and “footbed” both refer to insoles, footbeds, footbed assemblies, removable and non-removable insoles, midsoles and orthotic inserts.

In the present context the term “Shore” is used to define the hardness or stiffness of the pads in the footbeds or insoles as a measure of the resistance a material has to pressure or indentation.

In an embodiment of the present invention the outer perimeter of the footbed is at least partially upwardly extending.

In an embodiment of the present invention the longitudinal sides of the base of the footbed are raised from the ground.

In an embodiment of the present invention the footbed is a three-dimensional footbed.

In an embodiment of the present invention the three-dimensional footbed is formed by the outer perimeter of the footbed, the height of the base of the footbed and a plurality of pads, domes or protrusions on the base of the footbed.

In an embodiment of the present invention the plurality of pads, domes or protrusions on the base of the footbed comprises one or more of a heel pad, an outer sole pad, an inner sole pad, a metatarsal joints pad, and one or more toe pads, such as two to five toe pads.

In an embodiment of the present invention the footbed is a part of a footbed assembly, an insole, orthotic insert or forms a portion or the whole sole of a shoe.

In an embodiment of the present invention the difference between the footbed for each shoe size is 6.66 millimetres.

In an embodiment of the present invention the plurality of pads comprises a heel pad.

In an embodiment of the present invention the size of the heal pad may be 55 millimetres in width and 65 millimetres in length for a size 41 footbed. Furthermore, the thickness of the heal pad may be 3 millimetres at the middle point of the heal pad and then decreases gradually to the sides in all directions. Also, the hardness of the heal pad may be 35 shore.

In an embodiment of the present invention the size of the heal pad may be from 45 to 65 millimetres in width and from 55 to 75 millimetres in length for a size 41 footbed, such as from 50 to 60 millimetres in width and from 60 to 70 millimetres in length for a size 41 footbed.

In an embodiment of the present invention the thickness of the heal pad may be from 2.5 to 4 millimetres at the middle point of the heal pad, such as from 2.8 to 3.5 millimetres and then decreases gradually to the sides in all directions.

In an embodiment of the present invention the hardness of the heal pad may be from 25 to 45 shore, such as from 30 to 40 shore.

In an embodiment of the present invention the size of the heal pad is increased proportionally to the increase in length and width of the footbed for sizes 42 to 50.

In an embodiment of the present invention the size of the heal pad is decreased proportionally to the decrease in length and width of the footbed for sizes 40 to 34.

In an embodiment of the present invention the middle point of the heal pad is positioned to be underneath the middle of the heel bone (calcaneus).

In an embodiment of the present invention the centre of the heel pad is positioned to be underneath the middle of the heel bone and wherein the centre of the heel pad is the thickest portion of the heal pad with a gradual decrease in thickness towards the edges of the heal pad.

In an embodiment of the present invention the centre of the heel pad is positioned to be underneath the middle of the heel bone to provide cushioning and support for the knee joints, hip and spine, and wherein the centre of the heel pad is the thickest portion of the heal pad with a gradual decrease in thickness towards the edges of the heal pad without reaching the edge of the footbed for providing massage and/or stimulating the skin and blood vessels (above) the heel pad.

In an embodiment of the present invention the thickness of the heel pad is 3 mm, having a hardness of 35 shore when the upper layer is a leather cover.

In an embodiment of the present invention the thickness of the heel pad has an oval or circular shape, wherein the centre of the heel pad is the thickest portion of the heal pad with a gradual decrease in thickness towards the edges of the heal pad.

In an embodiment of the present invention the plurality of pads comprises an outer sole pad.

In an embodiment of the present invention the size of the outer sole pad may be 23 millimetres in width and 40 millimetres in length for a size 41 footbed. Furthermore, the thickness of the outer sole pad may be 3 millimetres at the highest point of the outer sole pad. Also, the hardness of the outer sole pad may be 35 shore.

In an embodiment of the present invention the size of the outer sole pad may be from 18 to 30 millimetres in width and from 35 to 55 millimetres in length for a size 41 footbed, such as from 20 to 25 millimetres in width and from 38 to 45 millimetres in length for a size 41 footbed.

In an embodiment of the present invention the thickness of the outer sole pad may be from 2.5 to 4 millimetres at the highest point of the outer sole pad, such as from 2.8 to 3.5 millimetres and then decreases gradually to the sides.

In an embodiment of the present invention the hardness of the outer sole pad may be from 25 to 45 shore, such as from 30 to 40 shore.

In an embodiment of the present invention the outer sole pad is positioned to be underneath the cuboid bone between the heel bone and the talus bone.

In an embodiment of the present invention the position and the shape of the outer sole pad provides support underneath and keeps the heel bone and the talus bone in a biomechanical position.

In an embodiment of the present invention the position and the shape of the outer sole pad provides support for individuals suffering from clubfoot, equinus foot, cavus foot, genu varum (knee-shin splints).

In an embodiment of the present invention the thickness of the outer sole pad is 3 mm, having a hardness of 35 shore when the upper layer is a leather cover.

In an embodiment of the present invention the outer sole pad has a half-moon shape.

In an embodiment of the present invention the thickest part of the outer sole pad along the longitudinal length of the pad is in the middle pad and then it gradually decreases in both directions.

In an embodiment of the present invention the position of the outer sole pad is diagonal along the raised outer longitudinal side of the base of the footbed.

In an embodiment of the present invention the plurality of pads comprises an inner sole pad.

In an embodiment of the present invention the size of the inner sole pad is 25 millimetres in width and 70 millimetres in length for a size 41 footbed.

In an embodiment of the present invention the thickness of the inner sole pad may be 3.5 millimetres at the highest point of the inner sole pad. Furthermore, the hardness of the inner sole pad may be 35 shore for a size 41 footbed.

In an embodiment of the present invention the size of the inner sole pad may be from 18 to 30 millimetres in width and from 60 to 80 millimetres in length for a size 41 footbed, such as from 20 to 27 millimetres in width and from 65 to 75 millimetres in length for a size 41 footbed.

In an embodiment of the present invention the thickness of the inner sole pad may be from 2.5 to 4.5 millimetres at the highest point of the inner sole pad, such as from 3 to 4 millimetres and then decreases gradually to the sides.

In an embodiment of the present invention the hardness of the inner sole pad may be from 25 to 45 shore, such as from 30 to 40 shore.

In an embodiment of the present invention the inner sole pad is positioned to be underneath the medial arch.

In an embodiment of the present invention the position and the shape of the inner sole pad provides support underneath medial arch.

In an embodiment of the present invention the thickness of the inner sole pad is 3.6 millimetres, having a hardness of 35 shore when the upper layer is a leather cover.

In an embodiment of the present invention the inner sole pad has the shape of half a circle or oval.

In an embodiment of the present invention the thickest part of the inner sole pad along the longitudinal length of the pad is in the middle pad and then it gradually decreases in both directions.

In an embodiment of the present invention the position of the inner sole pad is diagonal along the raised inner longitudinal side of the base of the footbed.

In an embodiment of the present invention the plurality of pads comprises a metatarsal joints pad.

In an embodiment of the present invention the size of the metatarsal joints pad is 45 millimetres in width and 50 millimetres in length for a size 41 footbed.

In an embodiment of the present invention the thickness of the metatarsal joints pad may be 4 millimetres at the middle point of the metatarsal joints pad and then decreases gradually to the sides in all directions. Also, the hardness of the metatarsal joints pad may be 45 shore.

In an embodiment of the present invention the size of the metatarsal joints pad may be from 35 to 55 millimetres in width and 40 to 60 millimetres in length for a size 41 footbed, such as from 40 to 50 millimetres in width and from 45 to 50 millimetres in length for a size 41 footbed.

In an embodiment of the present invention the thickness of the metatarsal joints pad may be from 2.5 to 5 millimetres at the middle point of the metatarsal joints pad, such as from 3.5 to 4.5 millimetres and then decreases gradually to the sides in all directions.

In an embodiment of the present invention the hardness of the metatarsal joints pad may be from 30 to 50 shore, such as from 35 to 45 shore.

In an embodiment of the present invention the highest point of the metatarsal joints pad is positioned to be underneath the highest point of the cirque behind the traverse arch formed by the heads of the five metatarsals.

In an embodiment of the present invention the foremost point of the metatarsal joints pad is positioned 174 millimetres from the heal (aftmost point) of the footbed (67% of the length of the foot).

In an embodiment of the present invention the foremost point of the metatarsal joints pad is positioned at the edge of articular surface of the second, the third and the fourth toe joints.

In an embodiment of the present invention the centre of the metatarsal joints pad is positioned to be at the middle of the width of the footbed.

In an embodiment of the present invention the metatarsal joints pad has an oval or circular shape.

In an embodiment of the present invention the thickness of the metatarsal joints pad is the thickest portion of the pad with a gradual decrease in thickness in all directions.

In an embodiment of the present invention the thickness of the metatarsal joints pad is 4 mm, having a hardness of 45 shore when the upper layer is a leather cover.

In an embodiment of the present invention the position and the shape of the inner sole pad provides support and/or remedy for individuals suffering from fallen metatarsal arch.

In an embodiment of the present invention the plurality of pads comprises a plurality of toe pads.

In an embodiment of the present invention the size of the toe pads may be 20 millimetres in diameters for the big toe pad and may be 10 millimetres in diameters for the remaining toe pads for a size 41 footbed. Also, the thickness of each of the toe pads may be 2 millimetres at the middle point of each toe pad. Furthermore, the hardness of the toe pads may be 50 shore.

In an embodiment of the present invention the size of the toe pads may be 15 to 25 millimetres in diameters for the big toe pad and may be from 5 to 15 millimetres in diameters for the remaining toe pads for a size 41 footbed, such as from 18 to 23 millimetres in diameters for the big toe pad and may be from 8 to 13 millimetres in diameters for the remaining toe pads for a size 41 footbed.

In an embodiment of the present invention the thickness of each of the toe pads may be from 1 to 3 millimetres at the middle point of each toe pad, such as from 1.5 to 2.5 millimetres at the middle point of each toe pad.

In an embodiment of the present invention the plurality of toe pads comprises a toe pad behind each of the five toes.

In an embodiment of the present invention the toe pads are positioned to be behind each toe-tip to provide massage to each toe as the user flexes each to during walking for increasing blood flow in the toes.

In an embodiment of the present invention the thickness of each of the toe pads is 2 millimetres, having a hardness of 50 shore when the upper layer is a leather cover.

In an embodiment of the present invention the insole including the plurality of pads are formed as an injection moulded single layer insole.

In an embodiment of the present invention a sole for making a shoe, with an insole including the plurality of pads is formed as an injection moulded sole.

In an embodiment of the present invention a shoe, with an insole including the plurality of pads is formed as an injection moulded shoe comprising a sole and an upper part.

In an embodiment of the present invention the injection moulded insole, sole or shoe is formed as a single moulded part from a continuous piece of material.

In an embodiment of the present invention the material for forming the injection moulded insole, sole or shoe is an EVA-based material.

In an embodiment of the present invention the hardness of the plurality of pads is from 5-60 shore, such as, but not limited to from 10-50 shore, or from 10-45 shore, or from 10-40 shore.

In an embodiment of the present invention the plurality of pads are 9 being positioned as follows:
the centre of the heel pad is positioned to be underneath the middle of the heel bone,
the outer sole pad is positioned to be underneath the cuboid bone between the heel bone and the talus bone,
the inner sole pad is positioned to be underneath the medial arch,
highest point of the metatarsal joints pad is positioned to be underneath the highest point of the cirque behind the traverse arch formed by the heads of the five metatarsals, and
the toe pads are positioned to be behind each toe-tip.

In an embodiment of the present invention the size of the footbed is calculated from shoe size 41, and wherein the length of the footbed is 26.3 centimetres for shoe size 41.

In an embodiment of the present invention the length of the footbed for shoe sizes above or below shoe size 41 is calculated be an increase or decrease of 6.66 millimetres for each shoe size respectively.

In an embodiment of the present invention the size of each of the plurality of pads in a footbed for shoe size 41 is: i) 55 millimetres in width and 65 millimetres in length for the heal pad, ii) 23 millimetres in width and 40 millimetres in length for the outer sole pad, iii) 25 millimetres in width and 70 millimetres for the inner sole pad, iv) 45 millimetres in width and 50 millimetres in length for the metatarsal joints pad, v) 20 millimetres in diameter for the big (Hallux) toe pad, and vi) 10 millimetres in diameter for the remaining toe pads.

In an embodiment of the present invention the size of each of the plurality of pads in a footbed is increased or decreased proportionately to the increase or decrease in the length of the footbed for each shoe size respectively.

In an embodiment of the present invention the size of each of the plurality of pads in a footbed is increased proportionally to the increase in length and width of the footbed for sizes 42 to 50.

In an embodiment of the present invention the size of each of the plurality of pads in a footbed is decreased proportionally to the decrease in length and width of the footbed for sizes 40 to 34.

In an embodiment of the present invention the thickness of each of the plurality of pads in a footbed for shoe size 41 is: i) 3 millimetres at the middle point of the heal pad, ii) 3 millimetres at the highest point of the outer sole pad, iii) 3.5 millimetres at the highest point of the inner sole pad, iv) 4 millimetres at the middle point of the metatarsal joints pad, and v) 2 millimetres for each of the toe pads.

In an embodiment of the present invention the hardness of each of the plurality of pads in a footbed is i) 35 shore for the heal pad, ii) 35 shore for the outer sole pad, iii) 35 shore for the inner sole pad, vi) 45 shore for the metatarsal joints pad, and v) 50 shore for each of the

In an embodiment of the present invention the upper layer is made from leather.

### DESCRIPTION OF VARIOUS EMBODIMENTS

The present invention will become more fully understood from the detailed description given hereinafter and the accompanying drawings which are given by way of illustration only, and thus, are not limitative of the present invention, and wherein:

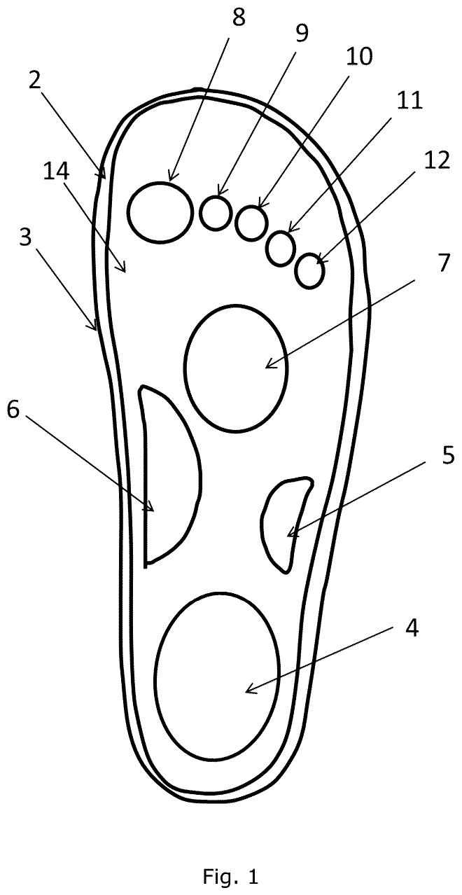

FIG. 1 is a schematic top view of a footbed according to one embodiment of the present invention.

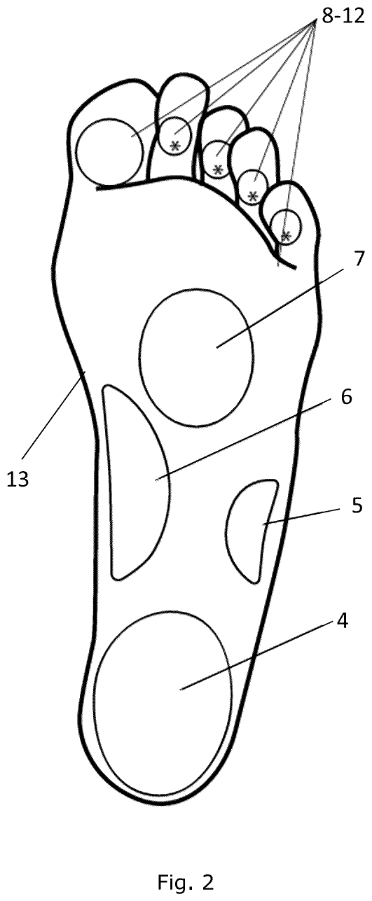

FIG. 2 shows the position of the pads in relation to the foot according to one embodiment of the invention.

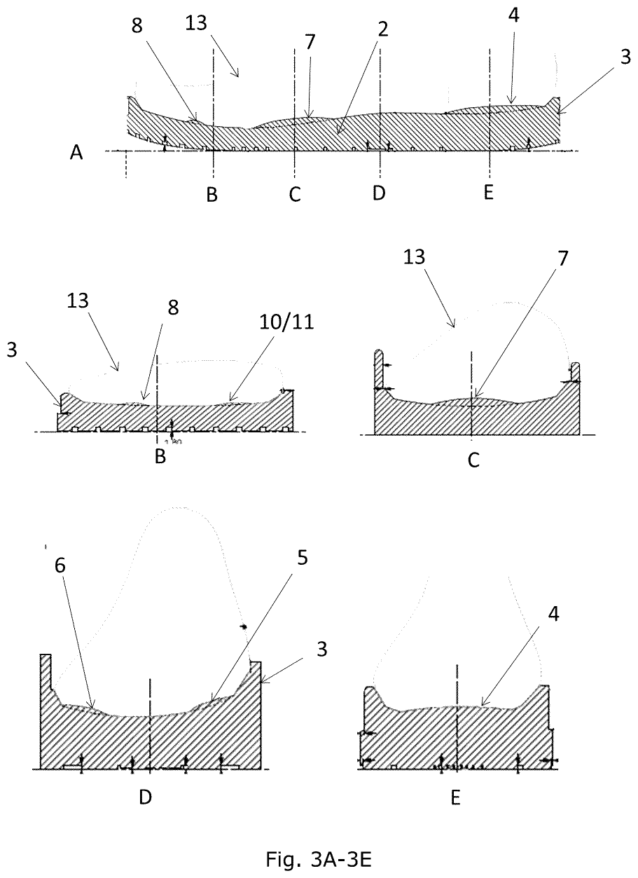

FIG. 3 shows section views of the insole.

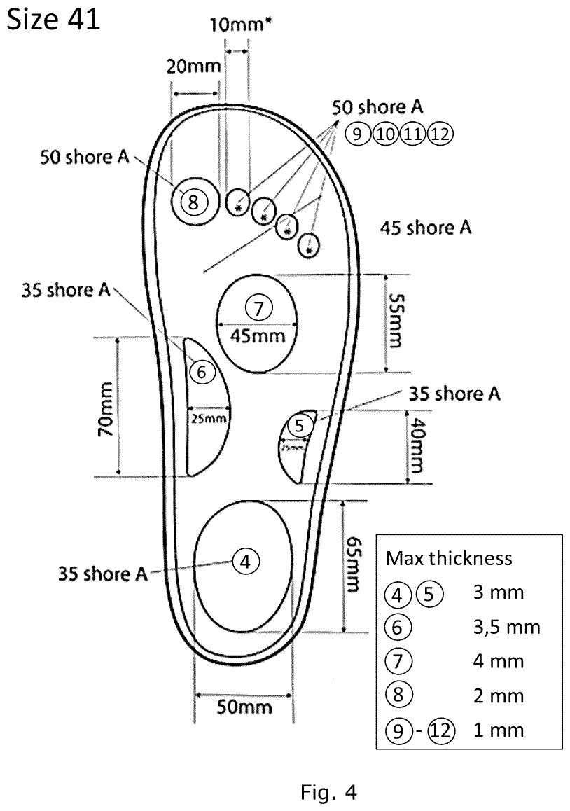

FIG. 4 shows an example of the size and shape of a padded insole for size 41.

FIG. 1 shows a schematic drawing of a footbed seen from above and indicating the position of each pad relative to an insole. The footbed assembly 1 shown in FIG. 1 has an upper layer 14 for supporting the foot 13, a base 2 with an outer perimeter 3 defining the edges of the footbed, and a plurality of pads as indicated in the drawing. The drawing shows a footbed with nine pads. An oval shaped heel pad 4 at the is shown as well as half-moon shaped outer sole pad 5 and an inner sole pad 6. A metatarsal joints pad 7 is shown in the middle part of the footbed and five toe pads 8-12 in the front part of the insole.

FIG. 2 shows the position of the pads in relation to the foot 13 according to one embodiment of the invention. First there is a heel pad 4, where the centre of the heel pad is positioned to be underneath the middle of the heel bone. The footbed also comprises an outer sole pad 5, positioned to be underneath the cuboid bone between the heel bone and the talus bone. Next there is an inner sole pad 6, positioned to be underneath the medial arch and a metatarsal joints pad 7, where the highest point of the metatarsal joints pad is positioned to be underneath the highest point of the cirque behind the traverse arch formed by the heads of the five metatarsals. The footbed shown in FIG. 2 has five toe pads 8-12, where each toe pads is positioned to be behind its respective toe-tip.

FIG. 3 shows a longitudinal mid-section view and four transection views of a footbed of the present invention outlining the three-dimensional shape of the footbed. A part of the foot 13 is also indicated in each section. First a longitudinal mid-section view (A) is shown where the four transection views (B-E) are indicated. The figure shows that the toe an the heal part of the outer perimeter 3 of the footbed are slightly raised at the toe and heal end of the insole. The figure also shows how the toe pad 8 for the big toe and both the metatarsal joints pad 7 and the heal pad 4 are raised from the base 2 of the footbed.

In the four transection views (B-E) of FIG. 3, it is shown that the footbed is raised along the outer perimeter 3 of the footbed for placing the foot in the insole or footbed. Transection (B) goes through toepads 8, 10 and 11 and indicating the foot 13 placed between the raised base of the footbed along the outer perimeter 3 of the footbed. Transection (C) shows the metatarsal joints pad where the centre of the metatarsal joints pad 7 is the thickest portion of the pad with a gradual decrease in thickness in all directions (see also the mid-section view A view). Transection (D) shows the outer sole pad 5 and the inner sole pad 6 positioned along the raised longitudinal side of the outer perimeter 3 of the footbed on each side. Transection (E) goes through the heel pad 4, where the centre of the heel pad is the thickest portion of the heal pad with a gradual decrease in thickness towards the edges of the pad.

FIG. 4 shows an embodiment of the present invention of the position and dimensions for a padded footbed of an orthotic insole for a size 41 footbed. The figure shows the base 2 of the footbed and nine pads forming. The oval shaped heel pad 4 is positioned with the centre of the heel pad 4 to be underneath the middle of the heel bone. The heal pad is 50 millimetres in width and 65 millimetres in length and the thickness of the heal pad is 3 millimetres at the middle point of the heal pad and then decreases gradually to the sides in all directions. Also, the hardness of the heal pad in this embodiment is 35 shore. The outer sole pad 5 is positioned to be placed under the cuboid bone between the heel bone and the talus bone having the shape of a half-moon. The outer sole pad is 23 millimetres in width and 40 millimetres in length for a size 41 footbed, having a. thickness of 3 millimetres at the highest point and a hardness of 35 shore. The inner sole pad 6 is positioned to be placed under the medial arch, having the shape of little less than half a circle. The inner sole pad is 25 millimetres in width and 70 millimetres in length having a thickness of 3.5 millimetres at the highest point of the pad and a hardness of 35 shore. The metatarsal joints pad 7 is positioned to be underneath the highest point of the cirque behind the traverse arch formed by the heads of the five metatarsals having an oval shape being 45 millimetres in width and 50 millimetres in length. The thickness of the metatarsal joints pad is 4 millimetres at the middle point of the metatarsal joints pad and then decreases gradually to the sides in all directions, where the hardness of the pad is 45 shore. The five toe pads 8-12 are to be positioned behind each respective toe-tip. The toe pads are circular in shape and size of the toe pad for the big toe is 20 millimetres in diameters, but 10 millimetres in diameter for the other four toe pads. The thickness for each pad is 2 millimetres at the middle point of each toe pad and the hardness is 50 shore.

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components.

The present invention also covers the exact terms, features, values and ranges etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

The term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

It will be appreciated that variations to the foregoing embodiments of the invention can be made while still falling within the scope of the invention. Features disclosed in the specification, unless stated otherwise, can be replaced by alternative features serving the same, equivalent or similar purpose. Thus, unless stated otherwise, each feature disclosed represents one example of a generic series of equivalent or similar features.

Use of exemplary language, such as “for instance”, “such as”, “for example” and the like, is merely intended to better illustrate the invention and does not indicate a limitation on the scope of the invention unless so claimed. Any steps described in the specification may be performed in any order or simultaneously, unless the context clearly indicates otherwise.

All of the features and/or steps disclosed in the specification can be combined in any combination, except for combinations where at least some of the features and/or steps are mutually exclusive. In particular, preferred features of the invention are applicable to all aspects of the invention and may be used in any combination.

1. A footbed 1 comprising:
a base, said base having an outer perimeter, and
a plurality of pads positioned within the outer perimeter the base,
wherein the plurality of pads comprises:
a heel pad,
an outer sole pad,
an inner sole pad,
a metatarsal joints pad, and
five toe pads.

2. The footbed according to claim 1, wherein the outer perimeter of the footbed is at least partially upwardly extending.

3. The footbed according to claim 1, wherein the height of the outer perimeter, the shape of the base and the shape of the plurality of pads form a three-dimensional shape of a footbed.

4. The footbed according to claim 1, wherein the base and the plurality of pads are formed as a single component.

5. The footbed according to claim 1, wherein the footbed is formed as an injection moulded single layer component from a continuous piece of material.

6. The footbed according to claim 4, wherein the material for forming the injection moulded single layer component footbed is an EVA-based material.

7. The footbed according to claim 1, wherein the footbed is a part of a footbed assembly, an insole, orthotic insert or forms a portion or the whole sole of a shoe.

8. The footbed according to claim 1, wherein the size and position of the pads is proportionally increased or decreased when making different size of footbeds from shoe size 41 for both larger and smaller size footbeds respectively.

9. The footbed according to claim 1, wherein the number of plurality of pads is nine, and wherein:
the centre of the heel pad is positioned to be underneath the middle of the heel bone,
outer sole pad is positioned to be underneath the cuboid bone between the heel bone and the talus bone,
the inner sole pad is positioned to be underneath the medial arch,
highest point of the he metatarsal joints pad is positioned to be underneath the highest point of the cirque behind the traverse arch formed by the heads of the five metatarsals, and
the toe pads are positioned to be behind each toe-tip.

10. The footbed according to claim 1, wherein the size of the footbed is calculated from shoe size 41 for both larger and smaller size footbeds.

11. The footbed to claim 1, wherein the size and position of the pads is proportionally increased or decreased when making different size of footbeds.

12. The footbed according to claim 1, wherein the difference between the footbed for each shoe size is 6.66 millimetres.

13. The footbed according to claim 1, wherein the size of each of the plurality of pads in a footbed for shoe size 41 is:
55 millimetres in width and 65 millimetres in length for the heal pad,
23 millimetres in width and 40 millimetres in length for the outer sole pad,
25 millimetres in width and 70 millimetres for the inner sole pad,
45 millimetres in width and 50 millimetres in length for the metatarsal joints pad,
20 millimetres in diameter for the big (Hallux) toe pad, and
10 millimetres in diameter for the remaining toe pads.

14. The footbed according to claim 1, wherein the thickness of each of the plurality of pads in a footbed for shoe size 41 is:
3 millimetres at the middle point of the heal pad,
3 millimetres at the highest point of the outer sole pad,
3.5 millimetres at the highest point of the inner sole pad,
4 millimetres at the middle point of the metatarsal joints pad,
2 millimetres for each of the toe pads.

15. The footbed according to claim 1, wherein the hardness of each of the plurality of pads in a footbed:
35 shore for the heal pad,
35 shore for the outer sole pad,
35 shore for the inner sole pad,
45 shore for the metatarsal joints pad,
50 shore for each of the toe pads.

16. A footbed assembly 1 comprising:
an upper layer,
a base, said base having an outer perimeter, and
a plurality of pads positioned on the base,
wherein the plurality of pads comprises:
a heel pad,
an outer sole pad,
an inner sole pad,
a metatarsal joints pad, and
five toe pads.

17. The assembly according to claim 16, wherein the upper layer is made from leather.

18. An injection moulded shoe comprising:
a sole, and
an upper part,
wherein the sole and the upper part are formed as a single moulded part from a continuous piece of material,
wherein the sole has a footbed comprising a base, said base having an outer perimeter and a plurality of protruded areas in the shape of pads to massage the foot during walking, and
wherein the plurality of pads comprises:
a heel pad,
an outer sole pad,
an inner sole pad,
a metatarsal joints pad, and
five toe pads.
